(19) United States
(12) Patent Application Publication
(10) Pub. No.: US 2013/0229519 A1
(43) Pub. Date: Sep. 5, 2013

(54) AUTOMATIC REAR VIEW DISPLAY IN VEHICLES WITH ENTERTAINMENT SYSTEMS

(71) Applicant: Madhav Kavuru, Poplar Bluff, MO (US)

(72) Inventor: Madhav Kavuru, Poplar Bluff, MO (US)

(21) Appl. No.: 13/517,586

(22) Filed: Jun. 13, 2012

Related U.S. Application Data
(60) Provisional application No. 61/605,748, filed on Mar. 1, 2012.

(51) Int. Cl. H04N 7/18

(52) U.S. Cl. 348/148; 348/E07.085

(57) ABSTRACT

An automatic rear view display includes a single camera configuration and a dual camera configuration. In the single camera configuration, as soon as an entertainment screen in a ceiling mounted entertainment system is opened or when the driver puts the vehicle in reverse, the view from a first camera proximate to the rear license plate is displayed on the rearview mirror. In the dual camera version, when the entertainment screen is opened, the view from a second camera near the roof of the vehicle is displayed in the rearview mirror. In the dual camera version if the driver puts the vehicle in reverse, with the entertainment screen open or closed, the view from a first camera would be displayed instead. In both versions as soon as the entertainment screen is closed (and the vehicle is not in reverse) the rearview mirror goes back to being a regular mirror.

### CROSS-REFERENCE TO RELATED APPLICATIONS

This application claims the benefit of U.S. Provisional Application No. 61/605,748 filed on Mar. 1, 2012, the contents of which are here in incorporated by reference.

### BACKGROUND OF THE INVENTION

The present invention relates to vehicle rear view displays and, more particularly, to an automatic rear view display in vehicles with entertainment systems.

Recently a feature that has become popular in many vehicles is the back-up assist display. This provides the driver a video image of the area immediately behind the vehicle, which is not visible through a normal rearview mirror. The back-up display is only activated when the vehicle is in reverse. Some vehicles have the back-up display in the dashboard. However, this is not an optimal place to put it since most drivers instinctively look at the rearview mirror when reversing. To solve this problem, the back-up assist display has been placed in the rearview mirror assembly itself as described in U.S. Pat. No. 7,230,523 B2. Optimally, the LED backlit LCD display is placed behind a transflective layer. This is a mirror layer that is partially reflective and partially transmissive. Thus, when the display is on, the full color image is visible to the driver as disclosed in U.S. Pat. No. 7,855,755 B2 and Patent Application Publication US2010/0201896 A1.

Another accessory that is increasingly popular is the ceiling mounted rear seat entertainment (RSE) system. The problem with RSE systems is that when the screen is down it obstructs the line of site from the rearview mirror to the rear of the vehicle. One approach to solve this problem can be seen in U.S. Pat. No. 7,564,479 where a second video display is mounted behind the entertainment screen. A camera in the rear of the vehicle provides an image feed to this display. Thus, when the driver looks in the rearview mirror, they will see a reflection of the image feed. There are numerous problems with this approach. First, the angles of the rearview mirror and entertainment screen affect the size and quality of the image. To avoid distortions, it is proposed that the rearview mirror and video screen be synchronized to move in tandem when the position of either the video screen or the rearview mirror is changed. Obviously, this can result in suboptimal viewing angle for the driver and/or the people in the rear seat(s). It is further proposed that an image processing system can be used to enhance or correct the image displayed on the video screen. Two other patent applications that also use a second video display mounted on the back of the entertainment screen are U.S. Patent Application publication 20070132894 A1 and U.S. Patent Application Publication 20080211735 A1. These approaches are unnecessarily complicated and expensive to implement.

Another approach to avoid these problems is to mount the entertainment screen on guide bar(s) as described in U.S. Pat. No. 7,333,009 B2. The screen can then be lowered so that the line of sight of the rearview mirror goes above the display unobstructed. This approach is better in theory than in practice. If there is more than one row of rear seating and the screen is lowered to the point where it doesn't obstruct the driver's rear view, the passengers in the second row would have difficulty viewing the screen because of the passengers and seating in front of them. Moreover, the guide bar(s) are mechanically cumbersome and prone to damage.

As can be seen from these various approaches, there is a need for a simpler, less expensive, and more reliable rearview display that overcomes these shortcomings.

### SUMMARY OF THE INVENTION

Every year, entertainment systems for passengers in the back of cars, minivans, and SUVs are becoming increasingly popular. These are sometimes also referred to as overhead flip down monitors or DVD (Digital Video Disk) entertainment systems. In these systems, the entertainment screen folds down from the ceiling so that the passengers in the rear can watch movies. However when the screen is down it obstructs the driver's view through the rearview mirror of traffic behind him. This is a safety hazard. To ensure driver safety and the best possible entertainment experience for rear seat passengers there is a need for a system that provides the driver with a clear view in the rearview mirror even when an entertainment screen is in the line of sight of the rearview mirror.

By placing an automatic switch (preferably a reed switch) in the ceiling mounted entertainment system, as soon as the entertainment screen is opened the view from a camera in the back of the vehicle is displayed on a rearview mirror with a built in LCD display. Two embodiments of the present invention include a single camera version and a dual camera version.

In some new vehicles, when the vehicle is in reverse, the image from the rearview camera is displayed on a screen in the center of the dashboard. Since this screen is also used to display the map of a GPS system, it would not be possible to display the rear view continuously during normal driving.

The present invention allows the screen in the center of the dashboard to be dedicated to the GPS system. Aftermarket rearview mirrors with LCD displays can easily be modified so that they continuously display the rear view during normal driving when the entertainment screen is down. Furthermore, it is more intuitive for the driver to look at the rearview mirror when reversing rather than looking at the screen in the dashboard.

Currently some auto manufacturers use a very small screen for the DVD Entertainment System to avoid blocking the driver's rear view. In contrast some more expensive vehicles have a DVD Ultrawide Rear Entertainment System standard. These do obstruct some of the driver's rear view. With the present invention, much larger entertainment screens can be used in all Rear Seat Entertainment Systems. As an added bonus, each vehicle would have the rearview camera system, which displays any small objects or children behind the vehicle when reversing. Thus this invention provides important safety features that would be beneficial to many drivers. In addition the rear passengers have a better entertainment experience because of the larger screen.

Throughout this specification the ceiling mounted LCD screen that is part of the rear seat entertainment system is simply referred to as the entertainment screen so as not to be confused with the LCD display built into the rearview mirror. Note that other types of displays in the entertainment system and rearview mirror that may become popular in the future, such as OLED or plasma flat panel are included in the scope of the invention. Instead of a DVD player the entertainment system could also be connected to a VCR, a videogame console, a television receiver, a flash memory media player, or a hard disk based media player.

The description below covers various aspects of the present invention and is provided as an overview of the invention, without limitation to additional embodiments as described herewithin and equivalents thereof.

In one aspect of the present invention, a rear view display system for a vehicle comprises a first camera positioned at the rear of a vehicle; a rearview mirror display disposed in a rearview mirror of the vehicle; and a control circuit adapted to send a first image from the first camera to the rearview mirror display when a rear seat entertainment screen is open and/or when the vehicle is in reverse.

In another aspect of the present invention, a rear view display system for a vehicle comprises a first camera positioned at the rear of a vehicle proximate to a license plate of the vehicle; a second camera positioned near the roof of the vehicle; a rearview mirror display disposed in a rearview mirror of the vehicle; a control circuit adapted to send a first image from the first camera to the rearview mirror display when the vehicle is in reverse and further adapted to send a second image from the second camera to the rearview mirror display when a rear seat entertainment screen is open; and a control circuit adapted to send a first image from the first camera to the rearview mirror display when the vehicle is both in reverse and the entertainment screen is open.

In a further aspect of the present invention, a method for viewing a region behind a vehicle comprises positioning a first camera at the rear of a vehicle; a rearview mirror display disposed in a rearview mirror of the vehicle; and controlling a display image on a rearview mirror display disposed in a rearview mirror of the vehicle, wherein a control circuit sends a first image from the first camera to the rearview mirror display when a rear seat entertainment screen is open and/or the vehicle is in reverse.

These and other features, aspects and advantages of the present invention will become better understood with reference to the following drawings, description and claims.

### BRIEF DESCRIPTION OF THE DRAWINGS

FIG. 1 is a perspective view of a rear view display system, in use, according to an exemplary embodiment of the present invention;

FIG. 2 is a side view of a vehicle showing one example of a dual camera installation;

FIG. 3 is a side view of a vehicle showing another example of a dual camera installation;

FIG. 4 is a side view of a rear seat entertainment system, in an open configuration, having a single pole double throw (SPDT) reed switch according to an exemplary embodiment of the present invention;

FIG. 5 is a side view of the rear seat entertainment system of FIG. 4 in a closed configuration;

FIG. 6 is a frontal section view of the rear seat entertainment system of FIG. 4 in a closed configuration;

FIG. 7 is a side view of a rear seat entertainment system, in an open configuration, having a second camera installed in the entertainment system facing toward the rear windshield of a vehicle, according to an exemplary embodiment of the present invention;

FIG. 8 is a side view of the rear seat entertainment system of FIG. 7 in a closed configuration;

FIG. 9 is a side view of a vehicle showing a dual camera installation using a second camera mounted in the entertainment system of FIG. 7;

FIG. 10 is an exemplary wiring diagram for a single camera rear view display system;

FIG. 11 is an exemplary wiring diagram for a dual camera rear view display system; and

FIG. 12 is a flow chart describing a dual camera rear view display system process, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Currently there are rearview mirrors with a built in LCD display that automatically show the view from a camera above the rear license plate when the vehicle is put in reverse. However, there are none that automatically show the rear view when an entertainment screen is opened. Moreover, there are currently no vehicles with two cameras in the rear of a vehicle as there are in the dual camera version of the present invention as described below. The view from the second camera is configured to approximate what the driver normally sees when looking through the rearview mirror. Thus the driver would have a better view of the traffic behind him. However the single camera version is less expensive and easier to retrofit existing vehicles. If there is another vehicle immediately behind the vehicle with the camera, the entire rear view could be obstructed by the front of that vehicle. However the single camera version would be adequate in most situations.

Broadly, the present invention provides an automatic rear view display in vehicles with entertainment systems that includes a single camera configuration and a dual camera configuration. In the single camera version, as soon as an entertainment screen in a ceiling mounted entertainment system is opened or the vehicle is put in reverse, the view from the camera is displayed on the rearview mirror. In the dual camera version, as soon as the entertainment screen is opened, the view from a second camera is displayed on the rearview mirror. In the dual camera version, if the driver puts the vehicle in reverse, with the entertainment screen open or closed, the view from a first camera would be displayed instead. This ensures the driver sees any small objects or children in close proximity to the car. In both versions as soon as the entertainment screen is closed (and the vehicle is not in reverse) the rearview mirror goes back to being a regular mirror.

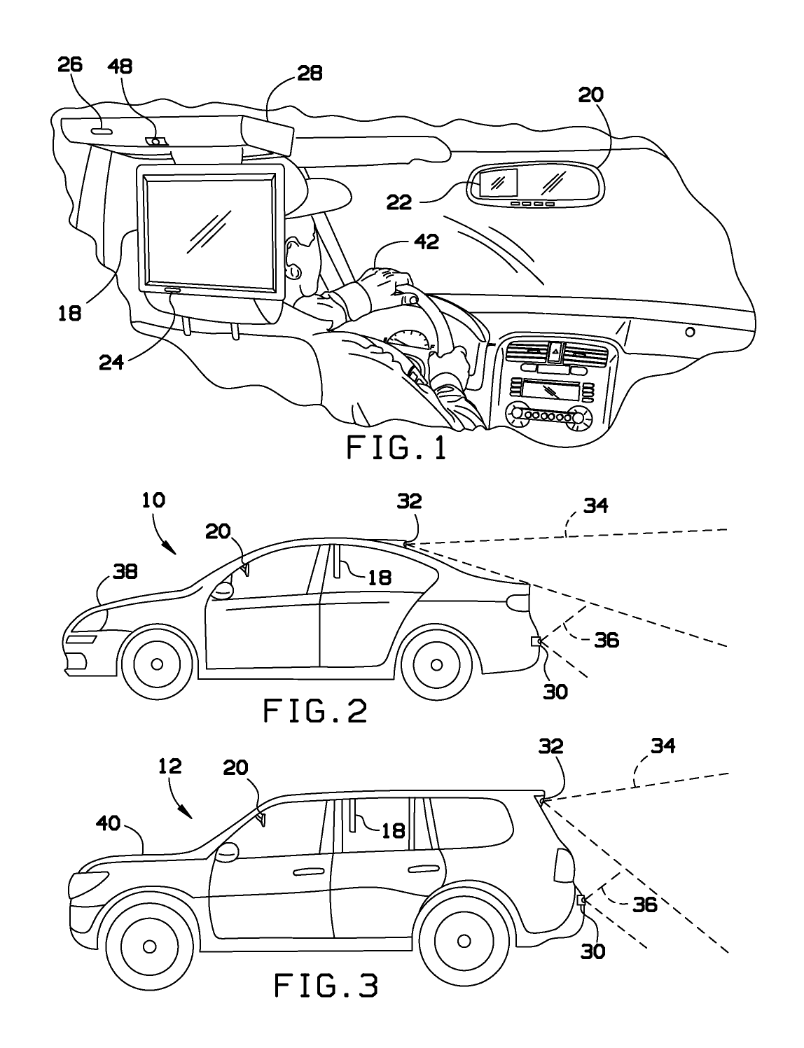

Referring now to the Figures, FIG. 1 shows the invention in use. When the entertainment screen 18 is open, blocking the line of sight of the rearview mirror 20 the driver 42 can see the rear view through the rear view display 22 built into the rearview mirror 20. This display 22 comes on automatically whenever the entertainment screen 18 is opened.

In the single camera version there is only one camera 30 on the back of the vehicle—just above the rear license plate with field of view 36 (this camera would be turned on when the vehicle is in reverse and/or when the entertainment screen is open). In the dual camera version there is an additional rear view camera 32, 48 with field of view 34, 52. The cameras send their video signal to a display screen 22 integrated into a rearview mirror 20.

In an exemplary embodiment of the present invention, with the single camera version, a first camera 30 would be placed just above the rear license plate. In another exemplary embodiment of the present invention, in the dual camera version, there are three possible locations for a second camera as described in greater detail below.

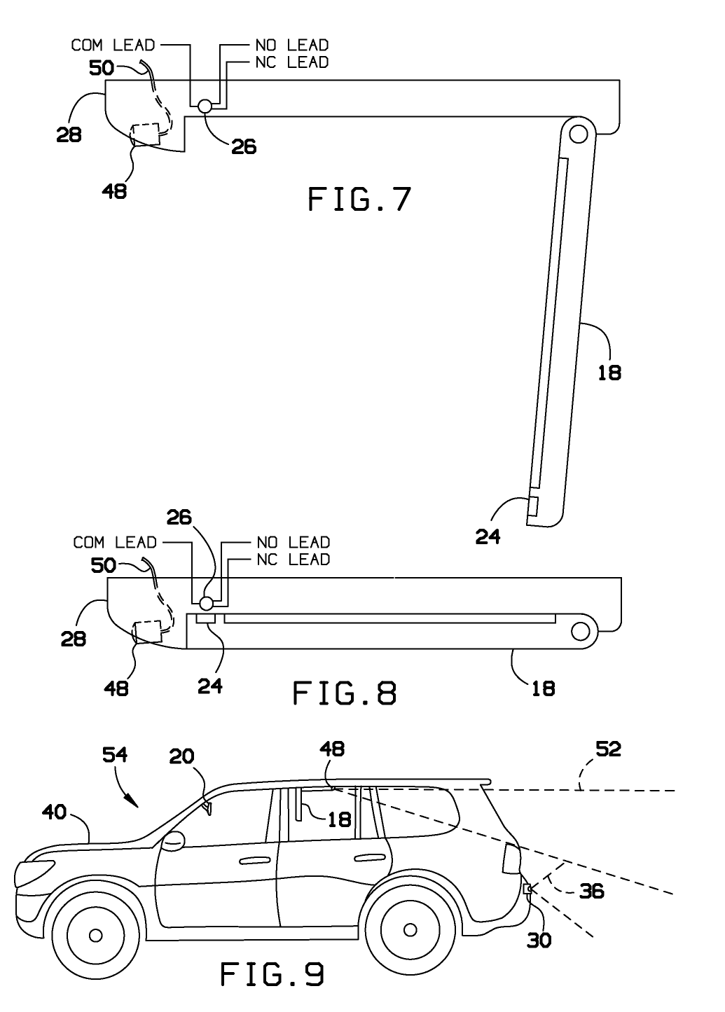

In new vehicles, the second camera 32 can be integrated into the exterior of the vehicle (such as a car 38 or an SUV/minivan 40) just above the rear windshield as shown in FIGS. 2 and 3. Alternatively, when retrofitting existing vehicles, a roof-mounted second camera 32 can be placed inside a vehicle in the center of the roof at the junction of the headliner and the top of the rear windshield with essentially the same field of view 34. Lastly a rear seat entertainment (RSE) system second camera 48 can be integrated into the rear edge of the entertainment LCD monitor base 28 as shown in FIGS. 7, 8, and 9. Since the cable 50 for the second camera 48 is right next to the SPDT reed switch 26, all the wiring 44 (as shown in FIG. 11) connecting the various components to the rearview mirror 20 can be done easily. Although the field of view 52 in this arrangement may not be as good as the first two arrangements 34, the driver does not have to worry about dirt, water spots, or ice obscuring the small lens of the camera. In this arrangement (RSE system mounted), the angle of the RSE system second camera 48 can be adjusted to accommodate different types of vehicles. In large SUVs, the RSE system second camera 48 can also be fitted with a small telephoto lens or a varifocal lens to achieve a narrow angle of view that includes less of the interior of the vehicle 54.

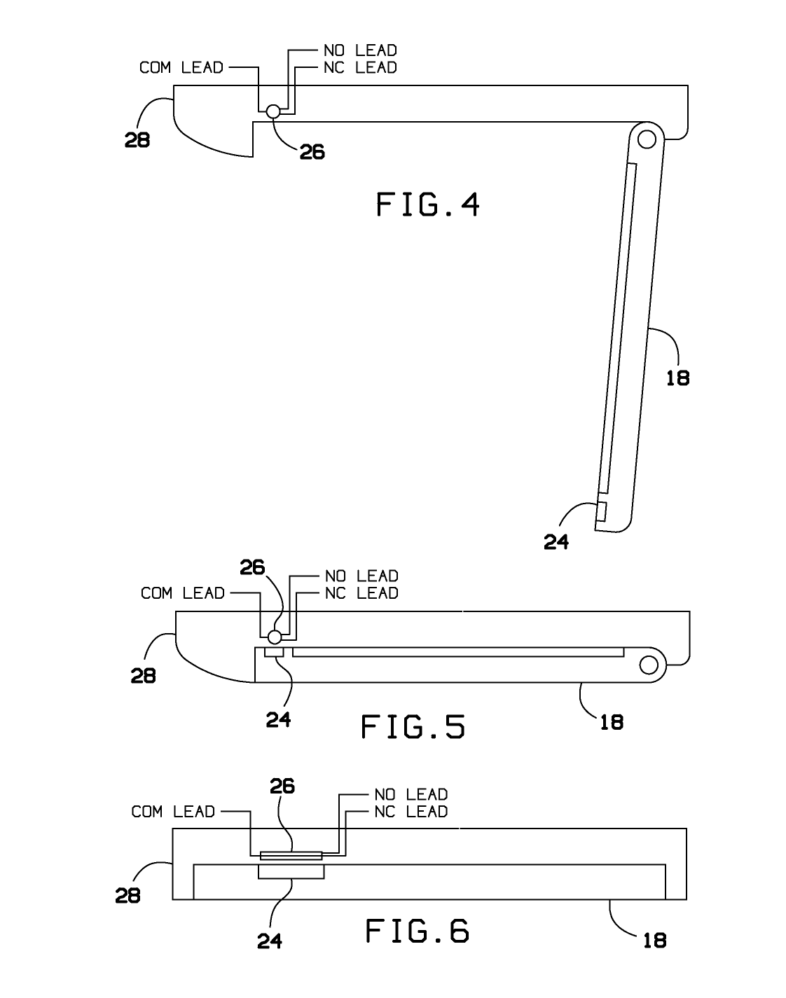

Referring now to FIGS. 4 through 6, the RSE system can include various types of switches 26 that may activate the rear view camera. The switches 26 can be turned on and off by opening and closing the RSE system. For example, when the screen 18 of the RSE system is open, a trigger mechanism 24 is positioned away from the switch 26, causing the switch to detect that the RSE system is open and directing signals accordingly.

In some embodiments, the switch 26 can be a single pole double throw (SPDT) reed switch (also called a standard changeover reed switch). The trigger mechanism 24 for the switch 26 would be a magnet in the edge of the entertainment screen 18. Such a switch can provide the user the option of a single or a dual camera installation based on the customer's budget and preference. Typically, the switch 26 can be installed in any RSE system in any vehicle, providing the user the option to install rear view cameras as desired. Since the switch only adds a few dollars to the cost of the entertainment system, the manufacturer can add it to all their models and market them as automatic rearview display (ARD) compatible systems. In both the single camera version and dual camera version, the rearview mirror 20, the SPDT reed switch 26, and the magnet 24 in the entertainment system are identical, however the wiring and number of cameras are different.

The system of the present invention can encompass all new rear seat entertainment systems with an automatic on/off switch incorporated in them. The present invention also encompasses any simple on/off switch (mechanical or electrical) which can be added to existing ceiling mounted entertainment systems. Solid state Hall effect sensors and many other designs for the switch are possible and are all within the scope of this invention. However, the simplest and most reliable switch is the SPDT reed switch which is described in this specification.

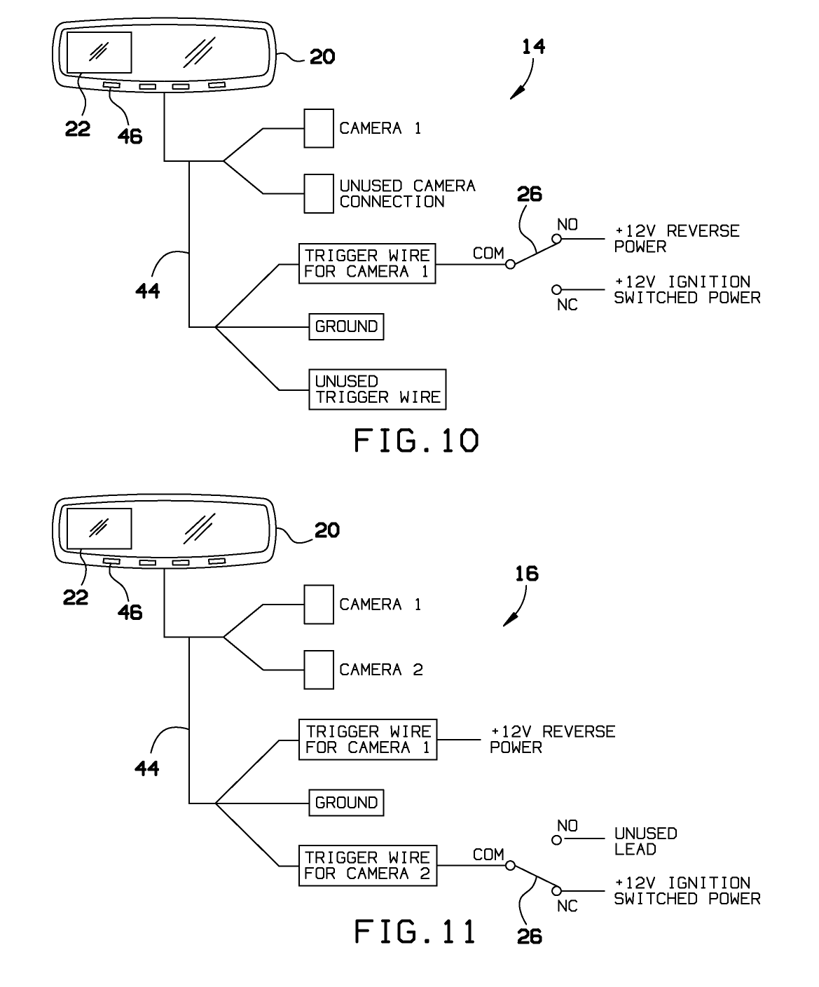

Referring now to FIG. 10, a single camera configuration 14 is shown according to an exemplary embodiment of the present invention. With only one camera connected to the rearview mirror 20, the trigger wire for this camera can be powered by either by +12V reverse power or +12V ignition switched power. In the configuration of FIG. 10, the +12V reverse power is connected to the normally open (NO) lead on the switch 26 and the +12V ignition switched power is connected to the normally closed (NC) lead on the switch 26. In this configuration, the common (COM) lead is connected to the trigger wire for the camera. When the entertainment screen 18 is closed and the magnet 24 is in close proximity to the switch 26, the circuit for +12V reverse power is completed and the circuit for +12V ignition switched power is broken. Thus, the rear view display 22 only comes on when the vehicle is put in reverse.

When the entertainment screen 18 is open and the magnet 24 is far away from the switch 26, the circuit for +12V reverse power is broken and the circuit for +12V ignition switched power is completed. Thus, the rear view display 22 is on when the screen 18 is open. When the vehicle is both in reverse and the screen 18 is open, the camera is still on and receives power from the ignition switched power source.

Referring to FIG. 11, a dual camera configuration 16 is shown according to an exemplary embodiment of the present invention. In this version, the +12V ignition switched power is connected to the NC lead of the switch 26 and the NO lead of the switch 26 is not used. In this version, the COM lead is connected to the trigger wire for the second camera 32, 48. When the entertainment screen 18 is closed and the magnet 24 is in close proximity to the switch 26, the NC circuit for ignition switched power is broken. The rear view display of the first camera 30 only comes on when the vehicle is put in reverse, because the trigger for the first camera 30 is reverse power, which is unaffected by the switch 26.

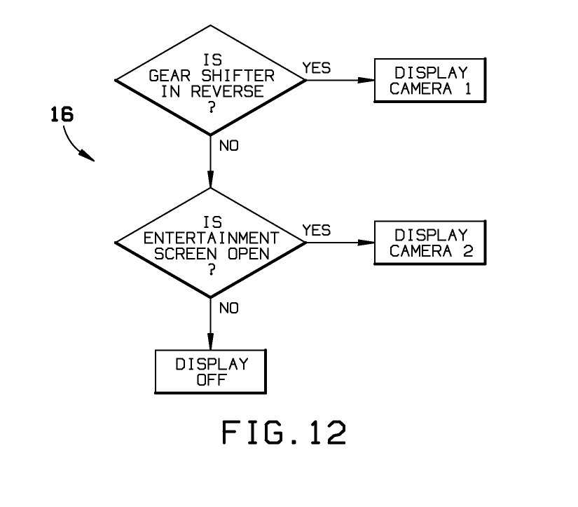

When the entertainment screen 18 is open and the magnet 24 is away from the switch 26, the NC circuit for ignition switched power is completed and the rear view display of the second camera 32, 48 comes on. If the vehicle is then put in reverse, the control unit gives priority to the image from the first camera 30 and displays its image instead of the image from the second camera 32, 48. This control logic is outlined in FIG. 12.

With the system of the present invention, vehicle manufacturers can make RSE systems with various sized screens without worrying about blocking a driver's rear view. Additionally, with the system of the present invention, the vehicle would have a rear view camera system which displays any small objects or children behind the vehicle when reversing, thus providing an important safety feature that would be beneficial to many drivers. Because the system of the present invention uses a rear view display 22 in the rearview mirror itself, drivers can continue to use their GPS systems in the dashboard while having the ability to continuously view the rear view display 22.

The rear view display 22 may include features to improve visibility of the image shown in the display 22. At night, headlights of vehicles in the rearview mirror could overwhelm the display 22, particularly if the only camera is the one above the rear license plate. The present invention can include an ambient light sensor and a plurality of control buttons 46, such as Manual Dim, Menu, + and −. By going into the menu, the driver can adjust the various settings, such as nighttime brightness of the rear view display 22 for the first camera 30 and the second camera 32, 48 separately.

Rearview mirrors 20 with built in LCD displays 22 are available through various manufacturers. For example, the Advent LCD M42 mirror monitor and the Pyle 10.2 inch mirror monitor with reverse camera are available. Additional rearview mirrors from other manufacturers are also available.

The features of this invention can either be incorporated in a rearview mirror that attaches directly to the front windshield or units that clip onto the existing rearview mirror. For a cleaner look, it would be advantageous to attach the rearview mirror directly to the windshield, replacing the factory rearview mirror.

The size of the high resolution LCD display 22 in the rearview mirror can be anywhere from 3.3″ to the full width of the mirror. If it is the full width, the user can select the size of the display. For example in the Pyle 10.2″ rearview mirror, the driver can select a display size of 4.5″, 5.6″, 7″, 8.5″, or 10.2.″ Logically, the aspect ratios corresponding to these widths would be 1:1/4:3/16:9/23:9/or 25:9. However, at the larger widths, the image could be somewhat distorted. Most people would probably find the LED backlit 4.2″ display on the left side of the mirror optimal, as is found in the Advent LCD-M42 Mirror Monitor. Other manufacturers include Chinavision, Accelevision, Gryphon Mobile, Boyo, Savv, Gentex, and Safesight. Any of these rearview mirrors can be adapted to work with this invention and consumers can decide which one they prefer.

As is standard on rear view displays, the image captured from the camera is inverted laterally before it is displayed. Thus it creates a mirror image similar to what a driver normally sees in a rearview mirror.

In both the single camera version and dual camera version, the first camera 30 could be equipped with night vision. Though the reverse lights provide some lighting when backing up at night, the LED array on a night vision camera further improves the image. In the dual camera version, the second camera 32, 48 would not have night vision capability since it would be largely ineffective and isn't needed there. However both the upper and lower cameras can be wide angle cameras with viewing angles of at least U30D30L60R60 degrees. In the settings, the driver can choose to have distance scale lines appear on the display when the first camera 30 is on. This helps the driver judge distances when reversing.

The driver can adjust the various settings by using the buttons 46 on the edge of the rearview mirror 20 as described above. In an alternative embodiment of this invention a touchscreen surface on the mirror 20 could be used instead to adjust the settings. The buttons 46 may be placed elsewhere, such as on a steering wheel, on the dashboard, or as a touchscreen on an in-dash display, for example.

While certain electrical configurations are described above, other configurations may be within the scope of the present invention. For example, the vehicle gear shifter could be equipped with an electronic sensor and switch to detect whether the gear is in reverse and completes or disconnects the circuit for the first camera 30.

To use the system of the present invention, the driver would not have to consciously do anything. As soon as the entertainment screen 18 is opened, the view from the rear camera appears on the rearview display 22. When the entertainment screen is closed the rearview mirror 20 goes back to being a regular mirror. When the driver puts the vehicle in reverse the view from the first camera will be displayed on the rear view display 22. The only thing that the driver must do is adjust the settings on the display to their satisfaction. Built into the rearview mirror is an image processing system, which alters at least one of brightness, clarity, contrast, sharpness, and color image parameters for the video signal. In the single camera version, the driver can set the daytime and nighttime brightness of the display separately. This way, when it is nighttime and there is a vehicle in the rearview mirror with its headlights on, the driver can set the nighttime brightness to a level that is comfortable for them. This ensures the headlights of cars behind him are not too bright. In the dual camera version, the driver would also be able to set the nighttime brightness separately for the upper and lower cameras, since there usually aren't any headlights on in the rear when reversing. Thus, the driver has a good image of what is behind the vehicle when reversing. The ambient light sensor allows the display to automatically adjust the brightness to the preset daytime or nighttime levels.

However in both the dual camera version and single camera version, there is also a Manual Dim On/Off button on the rearview mirror 20. This is for situations in daytime or nighttime when there is an excessive amount of glare landing on the camera, such as when the sun is directly behind the camera or the car in the rear has its high beams on. When the glare situation is over, the driver can press the Manual Dim On/Off button again to return to the normal brightness.

It should be understood, of course, that the foregoing relates to exemplary embodiments of the invention and that modifications may be made without departing from the spirit and scope of the invention as set forth in the following claims.

What is claimed is:

1. A rear view display system for a vehicle comprising:
a first camera positioned at the rear of a vehicle proximate to a license plate of the vehicle;
a rearview mirror display disposed in a rearview mirror of the vehicle; and
a control circuit adapted to send a first image from the first camera to the rearview mirror display when either a rear seat entertainment screen is open or the vehicle is in reverse.

2. The rear view display system of claim 1, wherein the control circuit sends the first image from the first camera to the rearview mirror display when the vehicle is in reverse.

3. The rear view display system of claim 1, further comprising a second camera connected to the control circuit, wherein the control circuit sends the first image from the first camera when the vehicle is in reverse and the control circuit sends a second image from the second camera to the rearview mirror display when the rear seat entertainment screen is open.

4. The rear view display system of claim 3, wherein the second camera is positioned either inside or outside the vehicle, above or along an upper edge of a rear windshield of the vehicle.

5. The rear view display system of claim 3, wherein the second camera is positioned inside the vehicle in a housing of the rear seat entertainment system itself.

6. The rear view display system of claim 3, wherein if the rear seat entertainment screen is open and the vehicle is in reverse the control circuit gives priority to the first image from the first camera so that the driver can see any small objects or children when reversing.

7. The rear view display system of claim 1, wherein the control circuit includes a single pole double throw reed switch.

8. The rear view display system of claim 3, wherein the rearview mirror display includes control circuitry that allows a user to set a daytime brightness and nighttime brightness separately for each camera.

9. The rear view display system of claim 5, wherein the second camera is fitted with a small telephoto or varifocal lens.

10. The rear view display system of claim 1, wherein the rear view display system includes at least one control to provide a manual dim control, a menu access, and menu adjustment and controls.

11. The rear view display system of claim 1, wherein the rear view display system includes a touchscreen surface and a graphical user interface to adjust various settings of the system.

12. A rear view display system for a vehicle comprising:
a first camera positioned at the rear of a vehicle proximate to a license plate of the vehicle;
a second camera positioned above the first camera;
a rearview mirror display disposed in a rearview mirror of the vehicle; and
a control circuit adapted to send a first image from the first camera to the rearview mirror display when the vehicle is in reverse and further adapted to send a second image from the second camera to the rearview mirror display when a rear seat entertainment screen is open.

13. The rear view display system of claim 12, wherein the second camera is positioned either inside or outside the vehicle, above or along an upper edge of a rear windshield of the vehicle.

14. The rear view display system of claim 12, wherein the second camera is positioned inside the vehicle in a housing of the rear seat entertainment system itself.

15. The rear view display system of claim 12, wherein if the rear seat entertainment screen is open and the vehicle is in reverse the control circuit gives priority to the first image from the first camera so that the driver can see any small objects or children when reversing.

16. The rear view display system of claim 12, wherein the control circuit includes a single pole double throw reed switch.

17. A method for viewing a region behind a vehicle, the method comprising:
positioning a first camera at the rear of a vehicle;
providing a rearview mirror display in a rearview mirror of the vehicle; and
controlling a display image on a rearview mirror display disposed on a rearview mirror of the vehicle, wherein a control circuit sends a first image from the first camera to the rearview mirror display when a rear seat entertainment screen is open.

18. The method of claim 17, further comprising sending the first image to the rearview mirror display when the vehicle is in reverse.

19. The method of claim 18, further comprising connecting a second camera to the control circuit, wherein the control circuit sends a second image from the second camera to the rearview mirror display when the rear seat entertainment screen is open, and sending the first image from the first camera when the vehicle is in reverse.

20. The method of claim 19, wherein the first camera is positioned proximate to a license plate of the vehicle and the second camera is positioned above the first camera.
